(19) United States
(12) Patent Application Publication
(10) Pub. No.: US 2002/0139548 A1
(43) Pub. Date: Oct. 3, 2002

(54) Ground rod driver

(76) Inventor: Paul F. Connelly JR., Trafford, PA (US)

Correspondence Address: JAMES RAY & ASSOCIATES, 2640 Pitcairn Road, Monroeville, PA, 15146, US

(21) Appl. No.: 09/819,201

(22) Filed: Mar. 28, 2001

(51) Int. Cl. B25D 9/00

(52) U.S. Cl. 173/90

(57) ABSTRACT

A driver for inserting an elongated object into the earth includes a body portion having an elongated cavity for receiving the elongated object. The elongated cavity has a blind end within the body portion, and the body portion has an impact surface substantially normal to the elongated cavity. The impact surface is for receiving impacts. There is also one or more elongated handles attached to the body portion, the elongated handle(s) being substantially parallel to the elongated cavity and spaced apart laterally from the elongated cavity.

### FIELD OF THE INVENTION

The present invention relates, in general, to devices for driving elongated objects such as rods or stakes into the earth and, more particularly, the present invention relates to drivers for electrical ground rods.

### BACKGROUND OF THE INVENTION

Electrical ground connections are a well known safety requirement in electrical systems. The purpose of such connections is to prevent persons from contacting conducting elements which are at elevated voltages. In a properly grounded system, a fault will result in a fuse or circuit breaker deenergizing the circuit rather than allowing a person to contact an elevated voltage. Residential electrical codes typically require a ground rod to be driven into the earth near the site on the residence where electrical power is brought into the residence. These ground rods may be of considerable length, and constitute a small target for a sledgehammer.

A number of extant patents describe apparatus for driving ground rods into the earth.

U.S. Pat. No. 5,863,154 “METHOD AND APPARATUS FOR INSTALLING GROUND RODS” cites a telescoping member for engaging the ground rod and a plunger mechanism attachable to the Kelly bar of hydraulic drilling equipment.

U.S. Pat. No. 5,426,126 “GROUND ROD DRIVER” teaches a tubular ground rod receiver having a ratcheting member at one end and a handle for engaging a prime mover at the other end. This invention does not appear to be operable without a prime mover.

U.S. Pat. No. 5,337,836 “GROUND ROD INSTALLATION TOOL” cites a tool having a hammer portion with a hollow handle for receiving the ground rod and a hammer head on the handle. A weight is attached to the hammer head. The tool is raised and lowered to provide impacts to begin driving the rod into the ground. The weight is then attached to the rod and is struck with the hammer portion to continue driving the rod into the ground.

U.S. Pat. No. 5,248,002 “GROUND ROD INSTALLATION METHOD” cites a tool having a hammer portion with a hollow handle for receiving the ground rod and a hammer head on the handle. A weight having a transverse aperture is attached to the hammer head. The tool is raised and lowered to provide impacts to begin driving the rod into the ground. The weight is then placed on the rod via its transverse aperture and is struck with the hammer portion to continue driving the rod into the ground.

U.S. Pat. No. 5,174,386 “GROUND ROD DRIVING APPARATUS” describes a hydraulic ground rod driver having a chuck to engage the ground rod and a hydraulic drive piston that impacts an anvil for driving the ground rod into the ground.

U.S. Pat. No. 5,086,849 “APPARATUS USEFUL IN DRIVING ELECTRICAL GROUND RODS” teaches a plurality of tubes bundled in parallel and having plug elements at various elevations for engaging the top end of a ground rod. An extension element including a portion the same diameter as the ground rod is included.

U.S. Pat. No. 5,029,427 “GROUND ROD DRIVER” claims a housing for receiving the rod and a clamping mechanism for engaging the rod at various elevations. The housing is to be struck by an impact tool such as a jackhammer.

U.S. Pat. No. 5,010,710 “GROUND ROD DRIVER” cites a tool having a housing for receiving the rod and a clamping mechanism for clamping the rod at various elevations. The housing is to be struck by an impact tool such as a jackhammer.

U.S. Pat. No. 4,688,969 describes an installation device having an auger for drawing the rod into the ground.

U.S. Pat. No. 4,641,715 “APPARATUS FOR DRIVING AND RETRACTING GROUND RODS OR THE LIKE” cites an apparatus having jaws for gripping the ground rod and is connectable to an anvil apparatus for manual or powered force-applying devices.

U.S. Pat. No. Des. 284,930 “GROUND ROD DRIVING HAMMER” claims a ground rod driver having an ornamental design.

U.S. Pat. No. 4,620,693 “POLE LIFTING APPARATUS” includes a feature for mounting a tool for driving a ground rod next to an electric line pole.

U.S. Pat. No. 4,557,409 “ELECTRICAL GROUNDING ROD DRIVING DEVICE” teaches a driving shaft having a recess in each end for the ground rod and a double-headed hammer slidingly encompassing the shaft.

U.S. Pat. No. 4,448,264 “GROUND ROD DRIVING POLE” describes a hollow pole for enclosing the rod. Transverse pins at By various locations on the pole engage the top of the ground rod. As the ground rod is lowered into the earth, the pole is raised and a different pin is used to engage the rod.

U.S. Pat. No. 3,910,556 “GROUND ROD DRIVING DEVICE” cites a generally tubular device for enclosing the ground rod. Transverse holes in the tubular device receive abutment members for engaging the top end of the ground rod. The device is for mounting on the boom of a mobile unit.

U.S. Pat. No. 3,732,935 employs a hydraulically driven impact hammer mounted on the boom of a vehicle.

Several of the preceding inventions require hydraulic or electrical impact devices. These have the disadvantage that expensive and bulky machinery must be available at the site. Furthermore, the impacts which electrical or hydraulic devices apply are generally weaker than the impact of a sledgehammer blow. If a ground rod which is driven by weak impacts encounters a rock, it is likely to be deflected around the rock, become bent, and may return to the surface. A ground rod driven by stronger blows from a sledgehammer is more likely to split a rock and not be bent.

Some of the patents cited above have the disadvantage of requiring considerable numbers of parts, and some have delicate components such as transverse pins or chucks for engaging the ground rod.

### SUMMARY OF THE INVENTION

In one aspect, the present invention is a driver for inserting an elongated object into the earth. The driver includes a body portion having an elongated cavity for receiving the elongated object, the elongated cavity having a blind end within the body portion. The body portion has an impact surface substantially normal to the elongated cavity. The impact surface is for receiving impacts from a hammer. There is also one or more elongated handles attached to the body portion, the elongated handle(s) being substantially parallel to the elongated cavity and spaced apart laterally from the elongated cavity.

In another aspect, the present invention is a driver for inserting an elongated object into the earth. The driver includes a body portion having an elongated cavity for receiving the elongated object, the elongated cavity having a blind end within the body portion. The body portion has an impact surface substantially normal to the elongated cavity, the impact surface being for receiving impacts from a hammer. A pair of handles are spaced laterally and oppositely from the cavity, the handles being substantially parallel to the elongated cavity.

### OBJECTS OF THE INVENTION

It is therefore one of the primary objects of the present invention to provide a ground rod driver which does not require hydraulic or electrical driving means.

Another object of the present invention is to provide a ground rod driver which is economical to fabricate.

An additional object of the present invention is to provide a ground rod driver having a rugged construction.

Yet another object of the present invention is to provide a ground rod driver which may easily be carried to the site where the ground rod is to be inserted.

It is a further object of the present invention to provide a driver for stakes or rods which provides for both positioning and striking of the rod or stake.

Another object of the present invention is to provide a ground rod driver which positions the rod during initial penetration of the earth and provides impact forces for driving the rod into the earth.

Still another object of the present invention is to provide a ground rod driver which can provide driving impacts to a rod having an upper end above the head of a person operating the driver.

Yet another object of the present invention is to provide a ground rod driver which tends to prevent deflection of the ground rod by stones in the earth.

An additional object of the present invention is to provide a ground rod driver having an impact surface which may be struck with a sledgehammer.

A further object of the present invention is to provide a ground rod driver having a rugged construction to accommodate off center sledgehammer blows.

Another object of the present invention is to provide a ground rod driver which may be held by one hand for inserting a ground rod obliquely into the earth.

A further object of the present invention is to substantially minimize the potential for injury to a person positioning the ground rod during insertion.

In addition to the various objects and advantages of the present invention which have been generally described above, there will be various other objects and advantages of the invention that will become more readily apparent to those persons who are skilled in the relevant art from the following more detailed description of the invention, particularly, when the detailed description is taken in conjunction with the attached drawing figures and with the appended claims.

### BRIEF DESCRIPTION OF THE DRAWINGS

FIG. 1 is an illustration of a presently preferred embodiment of a driver for inserting an elongated object into the earth.

FIG. 2 is a section of the driver shown in FIG. 1 cut along the line 2-2 in FIG. 1.

FIG. 3 is a section of the driver cut along the line 3-3 in FIG. 1.

FIG. 4 is a section cut along the line 4-4 in FIG. 1.

FIG. 5 is a section cut along the line 5-5 in FIG. 1.

FIG. 6 is an illustration of the driver with a pair of hand grips.

FIG. 7 is an illustration of the driver used to drive an elongated object obliquely into the earth.

FIG. 8 is an illustration of a slot in the driver which facilitates removal of impacted earth.

### BRIEF DESCRIPTION OF THE PRESENTLY PREFERRED AND VARIOUS ALTERNATIVE EMBODIMENTS OF THE INVENTION

Prior to proceeding to the much more detailed description of the present invention, it should be noted that identical components which have identical functions have been identified with identical reference numerals throughout the several views illustrated in the drawing figures for the sake of clarity and understanding of the invention.

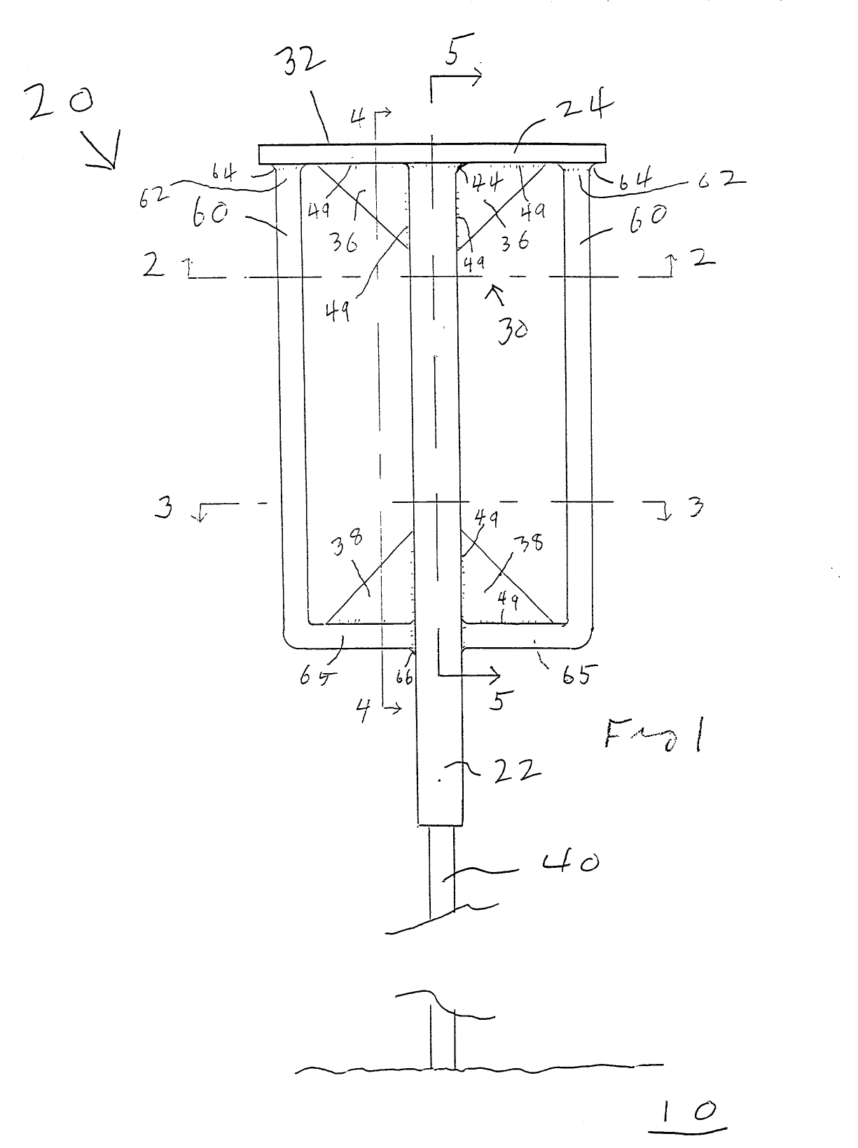

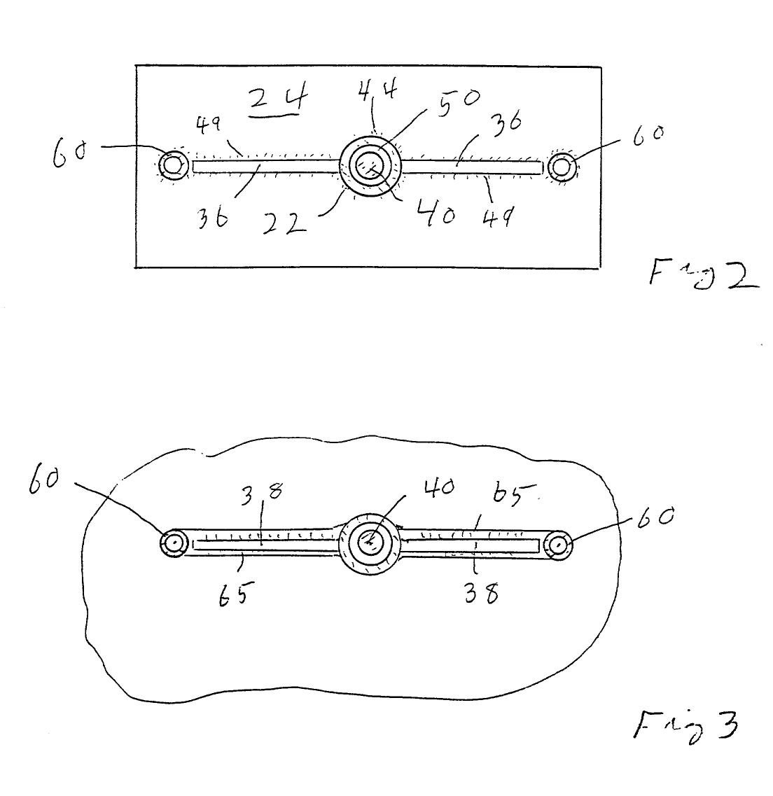

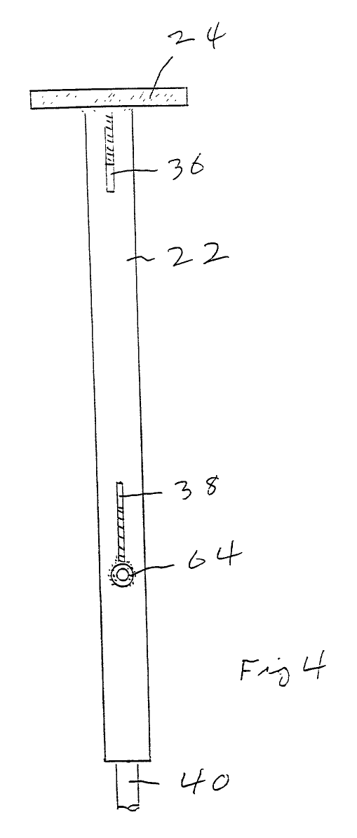

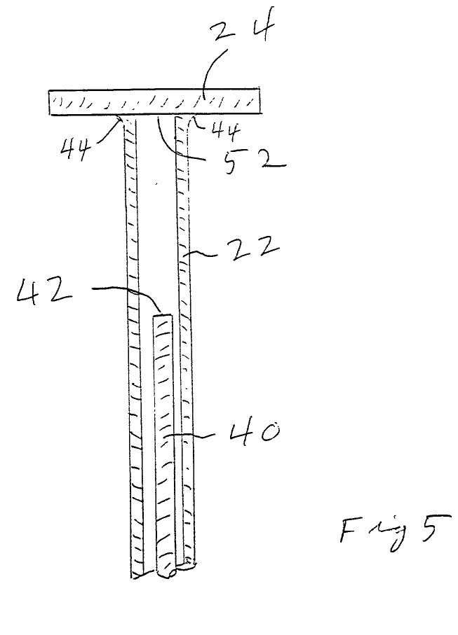

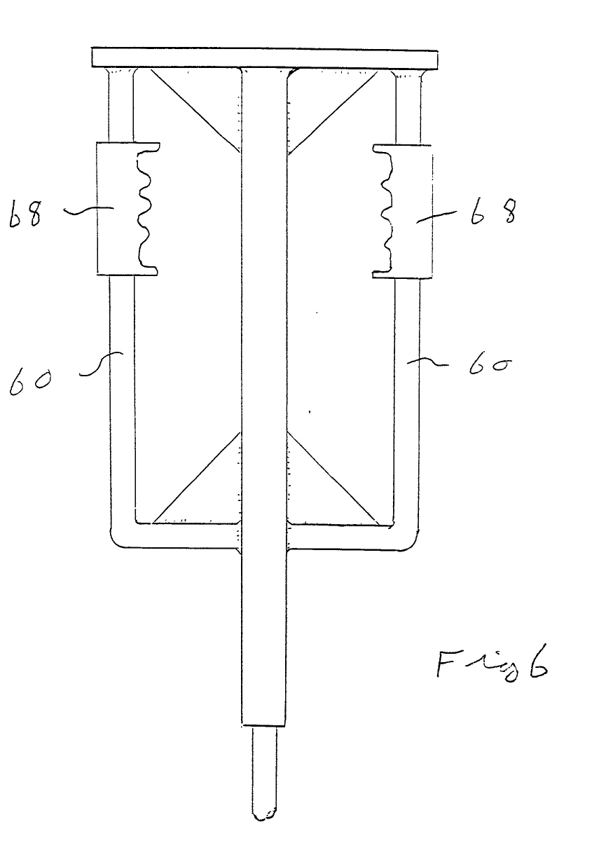

Attention is now directed to FIGS. 1 through 5 which illustrate the invention. The driver, generally designated 20, is for driving an elongated object, generally designated 40, into the earth, generally designated 10. Elongated object 40 may, for example, be a stake or a ground rod. Driver 20 has a body portion, generally designated 30, having an elongated cavity, generally designated 50. Driver 20 is for placement over elongated object 40 whereby a portion of such elongated object 40 is contained within the elongated cavity 50. Elongated cavity 50 has a blind end 52, best seen in FIG. 5, for contacting end 42 of such elongated object 40. Body portion 30 of driver 20 has an impact surface 32 which is for striking by an impact device (not shown), which typically is a sledgehammer. Impact surface 32 is substantially normal to the elongated cavity 50. Impact surface 32 has a substantially greater surface area than the end 42 of such elongated object 40 and is therefore a much better target for an impact device, such as a sledgehammer. Driver 20 includes at least one handle 60 attached to the body portion 30. Preferably, handle(s) 60 is/are disposed substantially parallel to elongated cavity 50.

Driver 20 may itself act as an impact device for initial penetration of the elongated object 40 into the earth 10. In this mode, driver 20 is placed over elongated object 40, then raised and brought downward briskly so that the blind end 52 impacts the upper end 42 of elongated object 40 to begin driving such elongated object 40 into the earth 10. In this mode, driver 20 both positions the elongated object 40 and provides impacts for driving object 40 into the earth 10. Driver 20 may be employed in this mode even if the end 42 of elongated object 40 is above the head of a person employing driver 20. It is presently preferred that driver 20 have two handles, as shown in FIGS. 1-3 to facilitate use in this mode. Preferably, driver 20 has sufficient mass to be employable as an impact device in this manner. Typically, the driver 20 has a mass in excess of about 2 kilograms.

In a typical application, driver 20 would be employed in the mode described above until the elongated object 40 has been driven sufficiently into earth 10 such that the end 42 is at an elevation for which a sledgehammer is convenient. Driver 20 would then be left in place over elongated object 40, whereby end 42 of the elongated object 40 contacts the blind end 52 of the elongated cavity 50. Surface 32 of driver 20 then provides a good target for a sledgehammer.

In the presently preferred embodiment, body portion 30 of driver 20 includes a pipe 22 joined by weld 44 to plate 24. Impact surface 32 is the upper surface of plate 24. In the presently preferred embodiment, in which driver 20 is a ground rod driver, pipe 22 is steel and has an outside diameter of about 1.25″ and a length of about 18″. Plate 25 has a thickness of about one half inch, a width of about 4″ and a length of about 9″.

Preferably, ends 62 of handles 60 are attached by welds 64 to plate 24. It is also preferred that handles 60 have transverse portions 65 and that transverse portions 65 are attached to pipe 22 by welds 66.

It is preferred that driver 20 have gussets 36 attached to plate 24 and pipe 22 by gusset welds 49 in order to withstand impacts on the surface 32 which are not in line with the elongated object 40.

Likewise, it is preferred that driver 20 have gussets 38 attached to pipe 22 and transverse portions 65 of handles 60 by gusset welds 49 to provide additional impact resistance.

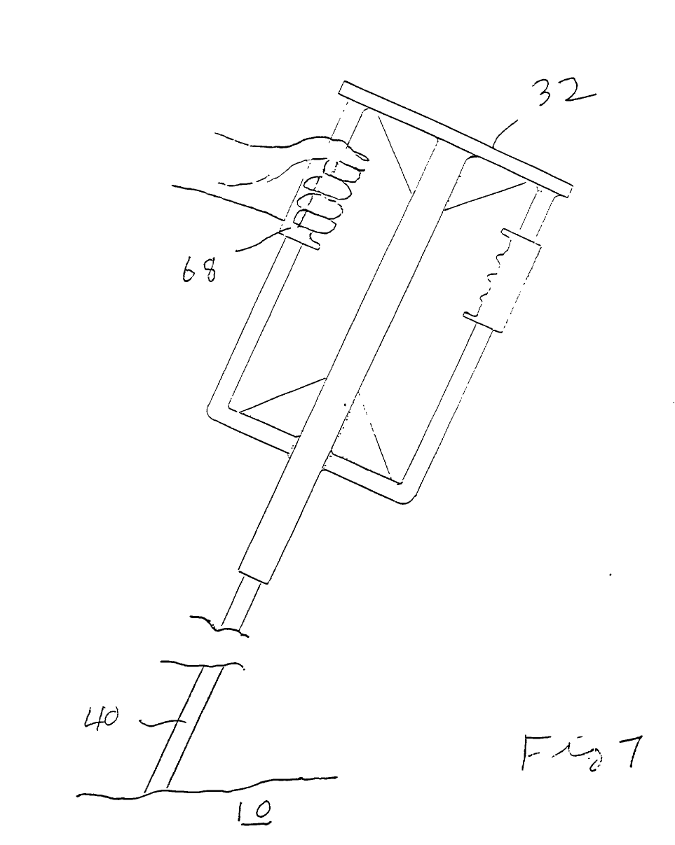

Attention is now directed to FIG. 6 which illustrates a pair of hand grips 68 which, preferably are attached to handles 60. Hand grips 68 are particularly helpful when driver 20 is employed as an impact device to begin the insertion of elongated object 40 into the earth 10.

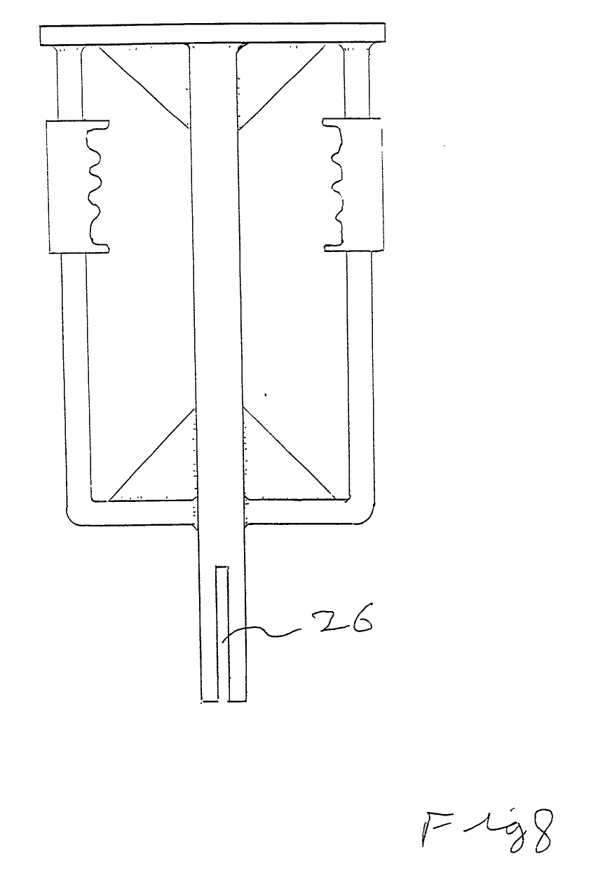

FIG. 7 illustrates the driver 20 employed during oblique insertion of an elongated object 40 into the earth 10. In this mode, driver 20 may be held by one hand, as shown, while impacts are applied to impact surface 32. Oblique insertion may be necessary when a shallow layer of soil overlays rock.

FIG. 8 illustrates a presently preferred feature, in which pipe 22 has a slot 26 at the end of pipe 22 which is remote from impact surface 32. Slot 26 should have a width less than the diameter of the elongated object 40 which is to be driven. For the presently preferred embodiment having dimensions cited above, slot 26 preferably has a width of about ¾″. and a length of about 4″. The purpose of slot 26 is to facilitate removal of earth which may become impacted in pipe 22 if use of driver 10 is continued after pipe 22 contacts the earth.

While a presently preferred embodiment of the instant invention has been described in detail above in accordance the patent statutes, it should be recognized that various other modifications and adaptations of the invention may be made by those persons who are skilled in the relevant art without departing from ids either the spirit of the invention or the scope of the appended claims.

I claim:

1. A driver for inserting an elongated object into earth, said driver comprising:
a body portion having an elongated cavity for receiving such elongated object, said elongated cavity having a blind end within said body portion;
an impact surface carried by said body portion, substantially normal to said elongated cavity, for receiving impacts; and
at least one elongated handle attached to said body portion.

2. A driver, according to claim 1, wherein said at least one elongated handle is substantially parallel to said elongated cavity and spaced apart laterally from said elongated cavity.

3. A driver, according to claim 1, wherein said impact surface has an area substantially greater than a cross section of said elongated cavity whereby said driver is a good target for a hammer.

4. A driver, according to claim 3, wherein said body portion includes a pipe attached normally to a plate and said impact surface is an upper surface of said plate.

5. A driver, according to claim 4, wherein said pipe is welded to said plate.

6. A driver, according to claim 5, further including at least one gusset welded to said plate and to said pipe.

7. A driver, according to claim 5 wherein said handle is welded to said plate at an end of said handle.

8. A driver, according to claim 7, wherein said handle further includes a transverse portion attached to said pipe at a location on said pipe spaced longitudinally from said plate.

9. A driver, according to claim 1, wherein said driver includes at least two elongated handles, said at least two elongated handles being spaced apart oppositely from said elongated cavity.

10. A driver, according to claim 9, wherein said body portion includes a pipe welded normally to a plate, and said two elongated handles are welded to said plate.

11. A driver, according to claim 10, further including at least two gussets welded to said pipe and to said plate.

12. A driver, according to claim 1, further having a hand grip on said at least one elongated handle.

13. A driver, according to claim 4, wherein said pipe has a slot at an end of said pipe remote from said plate, said slot being to facilitate removal of impacted earth from said pipe.

14. A driver for inserting an elongated object into earth, said driver comprising:
a body portion having an elongated cavity for receiving such elongated object, said elongated cavity having a blind end within said body portion;
an impact surface substantially normal to said elongated cavity, said impact surface being for receiving impacts from a hammer; and
a pair of handles spaced laterally and oppositely from said cavity, said handles being substantially parallel to said elongated cavity.

15. A driver, according to claim 14, having sufficient strength and mass to be employed as an impact device to provide impacts on such elongated object by said blind end of said elongated cavity.

16. A driver, according to claim 14, wherein said body portion includes a pipe attached normally to a plate and said impact surface is an upper surface of said plate.

17. A driver, according to claim 16, wherein said pipe is welded to said plate.

18. A driver, according to claim 17, further including two gussets, each of said gussets welded to said pipe and to said plate.

19. A driver, according to claim 18, wherein said handles are welded to said plate.

20. A driver, according to claim 19, wherein each of said handles further includes a transverse portion attached to said pipe at locations on said pipe spaced longitudinally from said plate.

21. A driver, according to claim 20, further including a pair of gussets welded to said transverse portions and to said pipe.
